(19) United States
(12) Patent Application Publication
(10) Pub. No.: US 2025/0289680 A1
(43) Pub. Date: Sep. 18, 2025

(54) Assembly and method for handling a string of consecutive medicament pouches

(71) Applicant: VMI Holland B.V., Epe (NL)

(72) Inventors: Patrick van Voorn, Epe (NL); Cornelis Jan Jochemsen, Epe (NL)

(73) Assignee: VMI Holland B.V., Epe (NL)

(21) Appl. No.: 18/858,771

(22) PCT Filed: May 10, 2023
(86) PCT No.: PCT/EP2023/062425

§ 371 Date: Oct. 22, 2024

(30) Foreign Application Priority Data
May 10, 2022 (NL) 2031811

(51) Int. Cl. B65H 23/195; A61J 1/03; B65D 75/42; B65H 18/08; B65H 23/00; B65H 26/04

(52) U.S. Cl. CPC B65H 23/1955; B65D 75/42; B65H 18/08; B65H 23/005; B65H 26/04; A61J 1/03; B65H 2301/414; B65H 2404/10; B65H 2557/30; B65H 2701/191; B65H 2701/1942; B65H 2801/81

(57) ABSTRACT

The invention relates to an assembly for handling a string of medicament pouches, wherein the assembly comprises a packaging device for packaging discrete medicaments in the respective medicament pouches, and a winding device for winding said string on a reel, wherein the assembly further comprises a control unit which is operationally connected to the packaging device and the winding device, wherein the control unit is arranged to:
receive one or more packaging status signals from the packaging device and to send one or more winding control signals to the winding device in response to said one or more packaging status signals; and/or
receive one or more winding status signals from the winding device and to send one or more packaging control signals to the packaging device in response to said one or more winding status signals.

### BACKGROUND

The invention relates to an assembly for handling a string of consecutive medicament pouches. The invention further relates to a method for handling a string of consecutive medicament pouches using the assembly.

### SUMMARY OF THE INVENTION

It is an object of the present invention to provide an assembly and a method for handling a string of consecutive medicament pouches in which the handling of the string of consecutive medicament pouches can be improved.

According to a first aspect an assembly for handling a string of consecutive medicament pouches is provided, wherein the assembly comprises a packaging device for packaging discrete medicaments in the respective medicament pouches of said string, and a winding device for receiving the string from the packaging device and winding said string on a reel, and a control unit which is operationally connected to said packaging device and said winding device, wherein the control unit is arranged to:
receive one or more packaging status signals from the packaging device and to send one or more winding control signals to the winding device in response to said one or more packaging status signals; and/or
receive one or more winding status signals from the winding device and to send one or more packaging control signals to the packaging device in response to said one or more winding status signals.

In other words, the control unit is operationally, electronically and/or functionally connected to provide a form of communication between the winding device and the packaging device. This can be wired or wireless communication depending on the system. Hence, in response to a detected status of the packaging device, the control unit can control the winding device to take an appropriate action and vice versa. The transport of the string through the packaging unit may for example be interrupted when a malfunction is detected at the winding device, to prevent accumulation of a large length of the string between the packaging device and the winding device. Moreover, the winding of the string of consecutive medicament pouches on the reel can be adapted automatically to the output of said string from the packaging device. Similarly, the output of the string of consecutive medicament pouches at the packaging device can be automatically adapted to the winding of said string on the reel. Hence, the string can be handled more reliably and/or excessive forces, which may break or damage the string can be prevented.

The control unit is further arranged to determine a winding status, based on the one or more winding status signals, that is indicative of one or more of:
an error in transporting the string between the packaging device and the winding device;
a difference between an output velocity of the string at a packaging output of the packaging device and a winding velocity of the string at the reel;
the reel being full; and/or
a malfunction of the winding device.

For example, the control unit may be arranged to determine a first winding status based on the one or more winding status signals, wherein the first winding status is indicative of an error in transporting the string between the packaging output and the reel. In particular, the first winding status may be indicative of the string not being properly connected to the reel or not being present at the winding device at all. In the case of said first winding status, the packaging device would continue to output the string op medicament pouches while said string would not be wound around the reel. Consequently, a length of the string would be outputted on the floor, creating an unmanageable tangle. Moreover, the string may be damaged in the process. The control unit can detect this status, such that appropriate action may be taken and/or directed by the control unit.

Additionally or alternatively, the control unit may be arranged to determine a second winding status based on the one or more winding status signals, wherein the second winding status is indicative of a winding velocity at the reel being higher than an output velocity of the string at the packaging output. Such a difference in velocity could stretch and, ultimately, break or rupture the string. The control unit can detect this status, such that appropriate action may be taken and/or directed by the control unit.

Additionally or alternatively, the control unit may be arranged to determine a third winding status based on the one or more winding status signals, wherein the third winding status is indicative of a winding velocity at the reel being lower than an output velocity of the string at the packaging output. In said third winding status, a tension in the string is decreased. In particular, the string could sag which may ultimately lead to the string being outputted on a factory floor. This may lead to damage to the string of medicine pouches. The control unit can detect this status, such that appropriate action may be taken and/or directed by the control unit.

Additionally or alternatively, the control unit may be arranged to determine a fourth winding status based on the one or more winding status signals, wherein the fourth winding status is indicative of the reel being full. When the reel is full, the string should be cut and the resulting leading end of the string should be coupled to a further reel. Accordingly, the full reel could be replaced for an empty reel. The control unit can detect this status, such that appropriate action may be taken and/or directed by the control unit.

Additionally or alternatively, the winding device may be arranged to determine a fifth winding status based on the one or more winding status signals, wherein the fifth winding status is indicative of a malfunction of the winding device. The control unit can thus detect the malfunction or error in the winding device, such that appropriate action may be taken and/or directed by the control unit.

In an embodiment thereof, the control unit is programmed to generate, in response to the detected winding status, a packaging control signal comprising one or more of the following instructions:
stopping the transport of the string by the packaging device;
increasing the output velocity of the string at the packaging output; and/or
decreasing the output velocity of the string at the packaging output.

For example, the control unit may be arranged to send a first packaging control signal to the packaging device in response to determining the first winding status, wherein the first packaging control signal comprises instructions to stop the transporting of the string by the packaging device. The first packaging control signal generated by the control unit can control the packaging device to take appropriate action, for example by ceasing the transport of the string by the packaging device. Hence, the abovementioned disadvantages can be prevented.

Additionally or alternatively, the control unit may be arranged to send a second packaging control signal to the packaging device in response to determining the fourth winding status, wherein the second packaging control signal comprises instructions to stop the transporting of the string by the packaging device. The control unit may further send a winding feedback signal to the winding device to stop the winding of the string on the reel. Hence, the transport of the string can be automatically paused when a reel is full. This may allow an operator or further device to exchange the full reel and to couple the string to a further reel.

In a further embodiment thereof, the control unit is further programmed to generate in response to the detected winding status, a winding feedback signal to be sent back to the winding device.

In a further embodiment thereof the winding feedback signal comprises one or more of the following instructions:
stopping the winding of the string by the winding device;
increasing the winding velocity of the string at the reel;
decreasing the winding velocity of the string at the reel; and/or
reversing a winding direction of the reel.

For example, the control unit may be arranged to send a first winding feedback signal or further winding control signal to the winding device in response to determining the second winding status, wherein the first winding feedback signal or further winding control signal comprises instructions to the winding device to decrease the winding velocity at the reel. Hence, the control unit can automatically take appropriate action to prevent the breaking or rupture of the string.

Additionally or alternatively, the control unit may be arranged to send a second winding feedback signal or further winding control signal to the winding device in response to determining the third winding status, wherein the second winding feedback signal or further control signal comprises instructions to the winding device to increase the winding velocity at the reel. Hence, the control unit can automatically take appropriate action upon detecting a decrease in the tension of the string.

Additionally or alternatively, the control unit may be arranged to send a third winding feedback signal or further winding control signal to the winding device in response to determining the fifth winding status, wherein the third winding feedback signal or further winding control signal comprises instructions to drive the reel in rotation in a direction opposite to the winding direction for a predetermined time interval. In other words, the string is at least partially unwound from the reel. Hence, a tension in the string can be reduced. The unwinding of the string may allow access to the winding device by an operator. Moreover, by reducing the tension in the string, the safety of said operator may be increased. Additionally, tearing of said string may be prevented.

In a further embodiment, the winding device comprises one or more sensors which are operationally connected to the control unit for detecting the presence or absence of a string of consecutive medicament pouches. The one or more sensors can detect the presence or absence of the string at a respective location along a string trajectory. The detection of the presence or absence of the string by one of the one or more sensors can serve as a winding status signal. The control unit can be arranged to detect the presence of a string at the winding device based on said winding status signals. Accordingly, the control unit can detect a winding status, such as one of the exemplary winding statuses as described above, and can, in response, send a packaging control signal to the packaging device.

In an embodiment thereof, the winding device comprises a dancer roller which defines at least a part of string trajectory between the packaging output and the reel, wherein the dancer roller is movable between a first position and a second position, wherein the dancer roller is biased towards the first position, wherein the dancer roller is arranged to be displaced towards the second position under the influence of the passing string, and wherein the one or more sensors comprise a dancer roller sensor or first sensor which is arranged to detect a presence of the dancer roller in at least one of the first position and the second position. Said dancer roller sensor may for example be a proximity sensor. In other words, the control unit can conveniently detect an absence of the string at the winding device based on the position of the dancer roller.

For example, the control unit may be arranged to determine the first winding status when the presence of the dancer roller in the first position is detected by said dancer roller sensor.

In a further embodiment, the one or more sensors comprise a second sensor which is arranged to detect a presence or absence of the string along a desired string trajectory. Said second sensor may for example be an optical sensor. A sensor along the desired string trajectory can conveniently detect an absence of the string and/or a deviation of the path of the string from the desired trajectory.

For example, the control unit may be arranged to determine the first winding status when the absence of the string is detected by the second sensor.

Additionally or alternatively, the control unit may be arranged to determine the second winding status when the second sensor detects the absence of the string and the dancer roller sensor detects the absence of the dancer roller in the first position thereof. In other words, an increased tension in the string, resulting from a winding velocity of the string at the reel being greater than an output velocity of the string at the packaging output may be detected by the combined winding status signals of the first and second sensor.

Additionally or alternatively, the control unit may be arranged to determine the third winding status when the second sensor detects the presence of the string and the dancer roller sensor detects the presence of the dancer roller in the first position thereof. The second sensor can detect that a string is present at the winding device, in contrast to the first winding status. The dancer roller sensor, however, can detect that the tension in said string is insufficient to displace the dancer roller. Hence, the control unit can reliably determine the third winding status. Moreover, the control unit can reliably distinguish the third winding status from the first winding status.

In a further embodiment, the one or more sensors comprise a path sensor or second sensor which is arranged to detect a presence or absence of a loop of the string outside, e.g. sagging below, a desired string trajectory. Optionally, the path sensor is an optical sensor. The path sensor can conveniently detect the presence of said loop.

When a desired string trajectory does not comprise said loop, the control unit may for example be arranged to determine the third winding status when the path sensor detects the presence of said loop of the string.

In a further embodiment, the one or more sensors comprise a reel sensor or third sensor which is arranged to detect an amount of the string of consecutive medicament pouches wound around the reel. The reel sensor may for example be a load cell for detecting the weight of the reel. Alternatively, the reel sensor may be a distance sensor for detecting a radius of the string that is wound around the reel. The control unit may be arranged to determine the fourth winding status when the detected amount of the string exceeds a predetermined threshold.

In a further embodiment, the winding device further comprises a winding drive for driving the reel in rotation and a torque sensor for measuring a torque of said winding drive. When the string is not coupled to the reel, the winding drive only rotates the reel, which can lead to a decreased torque. Hence, an absence of the string at the reel can be conveniently detected. The control unit may be arranged to determine the first winding status when the torque of the winding drive is below a predetermined threshold.

In a further embodiment, the control unit is arranged to determine a packaging status, based on the one or more packaging status signals, that is indicative of one or more of:
a sealing unit of the packaging device being opened
an error in transporting the string between the packaging device and the winding device;
a difference between an output velocity of the string at a packaging output of the packaging device and a winding velocity of the string at the reel;
the reel being full; and/or
a malfunction of the packaging device.

In an embodiment thereof, the control unit is programmed to generate, in response to the detected packaging status, a winding control signal comprising one or more of the following instructions:
stopping the winding of the string by the winding device;
increasing the winding velocity of the string at the reel;
decreasing the winding velocity of the string at the reel; and/or
reversing a winding direction of the reel.

For example, the control unit may be arranged to send a first winding control signal to the winding device in response to determining the first packaging status, wherein the first winding control signal comprises instructions to stop the winding of the string around the reel by the winding device. Hence, the control unit can automatically or autonomously take appropriate action in response to the first packaging status. By stopping the winding of the string around the reel, a tensioning or, ultimately, a rupture of the string can be prevented.

In an embodiment thereof, the control unit is further programmed to generate in response to the detected packaging status, a packaging feedback signal to be sent back to the packaging device.

In a further embodiment thereof, the packaging feedback signal comprises one or more of the following instructions:
stopping the transport of the string by the packaging device;
increasing the output velocity of the string at the packaging output; and/or
decreasing the output velocity of the string at the packaging output.

In a further embodiment, the winding device comprises a winding drive for driving the reel in rotation in a winding direction to wind the string around the reel.

In a further embodiment, the packaging device comprises a packaging drive for transporting the string through the packaging device.

In a further embodiment, the control unit comprises a non-transitory computer readable medium comprising instructions for processing the one or more winding status signals and/or the one or more packaging status signals and, in response, generating the respective one or more winding control signals and/or one or more packaging control signals, and a processing unit for executing said instructions.

According to a second aspect, the invention relates to a method for handling a string of consecutive medicament pouches using the assembly according to the first aspect of the invention, wherein the method comprises the steps of:
receiving one or more packaging status signals from the packaging device and sending one or more winding control signals to the winding device in response to said one or more packaging status signals; and/or
receiving one or more winding status signals from the winding device and sending one or more packaging control signals to the packaging device in response to said one or more winding status signals.

other words, the method involves communicating between the winding device and the packaging device. Hence, in response to a detected status of the packaging device, the appropriate action can be taken at the winding device and vice versa. Consequently, the winding of the string of consecutive medicament pouches on the reel can be adapted to the output of said string from the packaging device. Accordingly the output of the string of consecutive medicament pouches at the packaging device can be adapted to the winding of said string on the reel. Hence, the string can be handled more reliably. Moreover, excessive forces, which may break or damage the string can be prevented.

In an embodiment thereof, the method further comprises the step of determining a winding status, based on the one or more winding status signals, that is indicative of one or more of:
an error in transporting the string between the packaging device and the winding device;
a difference between an output velocity of the string at a packaging output of the packaging device and a winding velocity of the string at the reel;
the reel being full; and/or
a malfunction of the winding device.

In a further embodiment, the method further comprises the step of generating, in response to the detected winding status, a packaging control signal comprising one or more of the following instructions:
stopping the transport of the string by the packaging device;
increasing the output velocity of the string at the packaging output; and/or
decreasing the output velocity of the string at the packaging output.

In a further embodiment thereof, the method comprises stopping the transport of the string by the packaging device in response to a winding status indicative of an in error in transporting the string between the packaging output and the reel. In the case of an error in transporting the string between the packaging output and the reel, the packaging device would continue to output the string op medicament pouches while said string would not be wound around the reel. Consequently, a length of the string would be outputted on the floor, creating an unmanageable tangle. Moreover, the string may be damaged in the process. Ceasing the transport of the string by the packaging device can be an appropriate action to prevent the abovementioned disadvantages.

In a further embodiment, the method comprises increasing an output velocity of the string at a packaging output of the packaging device in response to a winding status indicative of a winding velocity at the reel being higher than the output velocity of the string. Such a difference in velocity could stretch and, ultimately, break or rupture the string. Increasing the output velocity at the reel can prevent the breaking or rupture of the string.

In a further embodiment, the method comprises decreasing an output velocity of the string at a packaging output of the packaging device in response to a winding status indicative of a winding velocity at the reel being lower than the output velocity of the string. In this particular winding status, the string could sag which may ultimately lead to the string being outputted on a factory floor. This may lead to damage to the string of medicine pouches. By decreasing the output velocity, sagging of the string can be prevented.

In a further embodiment, the method comprises stopping the transporting of the string by the packaging device in response to the reel being full. When the reel is full, the string should be cut and the resulting leading end of the string should be coupled to a further reel. Accordingly, the full reel could be replaced for an empty reel. The method comprises pausing the transport of the string when a reel is full. This may allow an operator or further device to exchange the full reel and to couple the string to a further reel.

In a further embodiment, the method further comprises the steps of generating in response to the detected winding status, a winding feedback signal and sending said winding feedback signal to the winding device. Optionally, the winding feedback signal comprises one or more of the following instructions:
stopping the winding of the string by the winding device;
increasing the winding velocity of the string at the reel;
decreasing the winding velocity of the string at the reel; and/or
reversing a winding direction of the reel. Hence, in addition to or instead of the packaging control signal, a winding feedback signal can be sent to the winding device. Accordingly, appropriate action in response to a detected winding status may be taken at the packaging device, at the winding device or at both the packaging and the winding device.

In a further embodiment thereof, wherein the method comprises decreasing a winding velocity at the reel in response to a winding status indicative of the winding velocity at the reel being higher than an output velocity of the string at a packaging output of the packaging device. Such a difference in velocity could stretch and, ultimately, break or rupture the string. Decreasing the winding velocity at the reel can prevent the breaking or rupture of the string.

In a further embodiment, the method comprises increasing a winding velocity at the reel in response to a winding status indicative of the winding velocity at the reel being lower than an output velocity of the string at a packaging output of the packaging device. In this particular winding status, the string could sag which may ultimately lead to the string being outputted on a factory floor. This may lead to damage to the string of medicine pouches. By increasing the winding velocity, sagging of the string can be prevented.

In a further embodiment, the method comprises rotating the reel in a direction opposite to the winding direction for a predetermined time interval in response to a malfunction of the winding device. In other words, the string is at least partially unwound from the reel. Hence, a tension in the string can be reduced. The unwinding of the string may allow access to the winding device by an operator. Moreover, by reducing the tension in the string, the safety of said operator may be increased.

In a further embodiment, the method comprises the step of determining a packaging status, based on the one or more packaging status signals, that is indicative of one or more of:
a sealing unit of the packaging device being opened;
an error in transporting the string between the packaging device and the winding device;
a difference between an output velocity of the string at a packaging output of the packaging device and a winding velocity of the string at the reel;
the reel being full; and/or
a malfunction of the packaging device.

In an embodiment thereof, the method further comprise generating, in response to the detected packaging status, a winding control signal comprising one or more of the following instructions:
stopping the winding of the string by the winding device;
increasing the winding velocity of the string at the reel;
decreasing the winding velocity of the string at the reel; and/or
reversing a winding direction of the reel.

In a further embodiment thereof, the method comprises stopping the winding of the string around the reel by the winding device in response to a malfunction of the packaging device. By stopping the winding of the string around the reel, a tensioning or, ultimately, a rupture of the string can be prevented.

In a further embodiment, the method further comprises the steps of generating in response to the detected packaging status, a packaging feedback signal and sending said packaging feedback signal back to the packaging device. Optionally, the packaging feedback signal comprises one or more of the following instructions:
stopping the transport of the string by the packaging device;
increasing the output velocity of the string at the packaging output; and/or
decreasing the output velocity of the string at the packaging output.

According to a third aspect, the present invention relates to a computer-readable medium having computer-executable instructions adapted to cause the control unit of the invention to execute the method of the invention. The computer-readable medium implements the method of the present invention. Hence, the same advantages as described above apply equally.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIGS. 1-4 show an assembly comprising an assembly according to an embodiment of the present invention during exemplary process steps;

FIG. 5 shows a detailed view of the connection between the reel and the winding device according to the circle V in FIG. 1; and

FIGS. 6 and 7 show front views of the detail of FIG. 5 in different operational conditions.

### DETAILED DESCRIPTION OF THE INVENTION

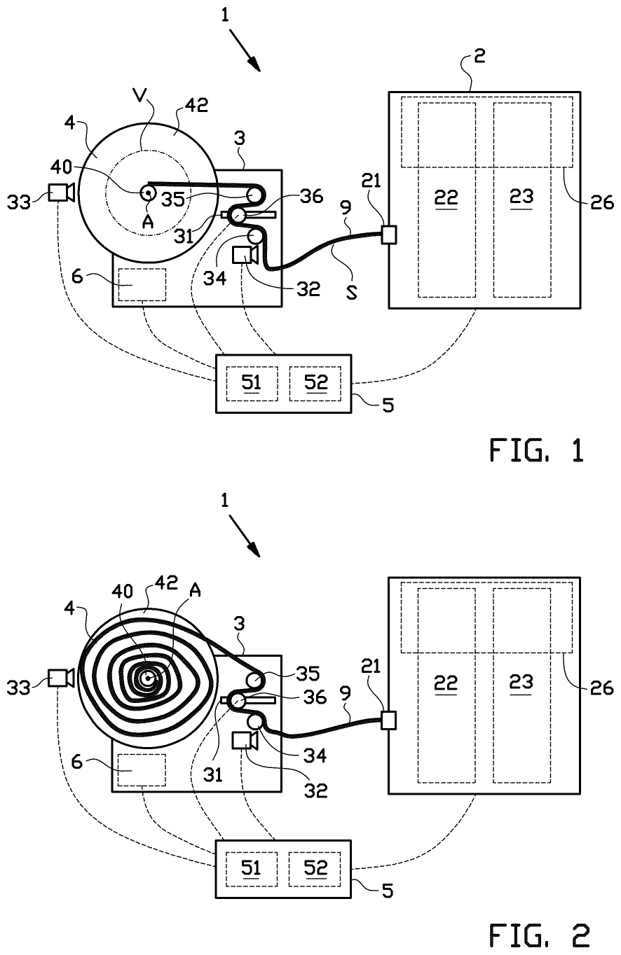

FIGS. 1-4 show an assembly 1 for handling a string 9 of consecutive medicament pouches. The assembly 1 comprises a packaging device 2 for packaging discrete medicaments in the respective medicament pouches of said string 9. The assembly 1 further comprises a winding device 3 for receiving the string 9 from the packaging device 2 and winding said string 9 on a reel 4.

As is further shown in FIGS. 1-4, the packaging device 2 comprises a filling station 23 for filling the respective consecutive medicament pouches of the string 9. In particular, said filling station 23 is arranged for dispensing a predetermined amount of discrete medicaments into a respective medicament pouch. The packaging device 2 further comprises a sealing station 22 for sealing the filled medicament pouches.

The packaging device 2 further comprises a packaging output 21 for outputting the string 9 of consecutive medicament pouches. The packaging device 2 comprises a packaging drive 26 for transporting the string 9 of consecutive medicament pouches through the packaging device 2. In particular, the packaging drive 26 is arranged for transporting the string 9 of consecutive medicament pouches through said filling station 23 and said sealing station 22 to said packaging output 21.

Typically, an elongate web (not shown) is fed to the packaging device 2 to be formed into the string 9 of consecutive medicament pouches. The packaging device 2 may be arranged to form at least a part of the respective medicament pouches in said web, for example by applying a series of heat seals to an elongate web. Alternatively, the pouches may be pre-formed in the elongate web before said web is fed to the packaging machine 2.

The packaging drive 26 is typically arranged for intermittent transport of the string 9 of consecutive medicament pouches to allow the feeding of the medicaments into the respective pouches of said string 9 at the filling station 23 and/or to allow a secure sealing of the respective pouches of the string 9 at the sealing station 22. The packaging drive 26 may comprise a buffer mechanism (not shown), such as a dancer, to mitigate the intermittent transport at of the string 9 at the packaging output 21. In particular, such a buffering mechanism may allow a constant or substantially constant output of the string 9 at the packaging output 21.

As is shown in FIGS. 1-4, the reel 4 is provided with a central hub or reel hub 40 extending along a central axis A. The reel 4 further comprises two flanges 42. The flanges 42 are spaced apart in an axial direction parallel to the central axis A for confining the string in said axial direction. The flanges 42 are connected to the reel hub 40 and extend away from said hub 40 in a radial outward direction with respect to the central axis A.

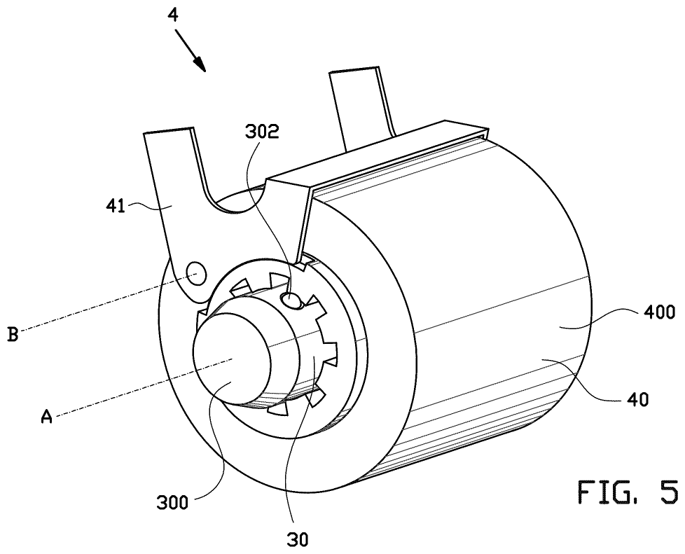

As can best be seen in FIGS. 5-7, the reel hub 40 further comprises a support surface 400 for receiving the string 9. The support surface 400 extends circumferentially about the central axis A. The reel 4 further comprises a clamp 41 for clamping a leading end of the string 9 to the support surface 400. Said clamp 41 is rotatable about a clamp axis B. The clamp axis B is parallel to central axis A. In particular, the clamp axis B is spaced apart from central axis A. Optionally, the clamp 41 is biased towards the support surface 400.

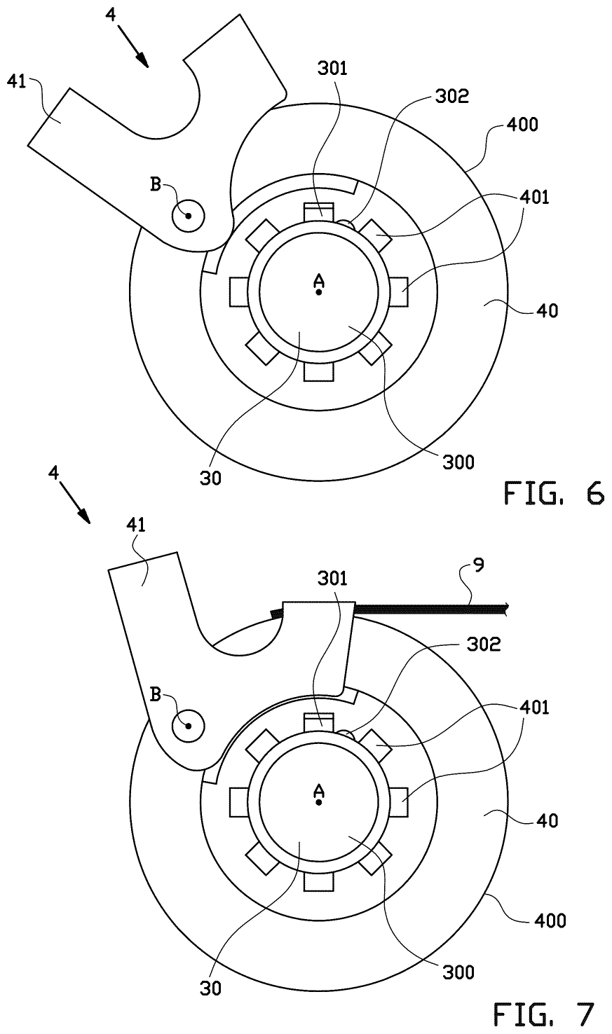

The winding device 3 comprises a coupling member 30 for receiving the reel 4. The coupling member 30 comprises a drive shaft 300 for driving the reel 4 in rotation about the central axis A. As is shown in FIGS. 6 and 7, the drive shaft 300 is a keyed drive shaft 300 comprising a notch, cam or key 301 protruding from said drive shaft 300 in a radial direction transverse or perpendicular to the central axis A. Alternatively, the drive shaft 300 may for example comprise a plurality of notches, cams or keys 301 distributed circumferentially about the central axis A. Said notch, cam or key 301 is arranged to engage the reel 4 for driving said reel 4 in co-rotation with the drive shaft 300.

As is further shown in FIGS. 5-7, the coupling member 30 comprises a retaining member 302 for retaining the reel in an axial direction parallel to the central axis A. The retaining member 302 is movable into a retaining position in which said retaining member 302 protrudes radially from the drive shaft 300. In this particular embodiment, the retaining member 302 is further movable in a retracted position in which the retaining member 302 does not protrude from the drive shaft 300 to release the reel 4 from the coupling member 30. In particular, the retaining member 302 is spring loaded into the retaining position. Hence, the reel can be conveniently removed by counteracting spring load on the retaining member 302 and subsequently sliding the reel 4 over the drive shaft 300.

As is further shown in FIGS. 5-7, The reel 4 is provided with a central bore extending through the reel hub 40 along the central axis A for receiving the coupling member 30 of the winding device 3. The reel 4 comprises one or more grooves or key lanes 401 for receiving the notch or key 301 of the coupling member 30. In this particular embodiment, the grooves or key lanes 401 are distributed circumferentially about the central axis A. In particular, the grooves or key lanes 401 are distributed evenly about the central axis A.

Preferably, the retaining member 302 is displaced in the circumferential direction with respect to the cam, notch or key 301, such that the retaining member 302 is not aligned with a groove or key lane 401 of the reel 4.

In this particular embodiment, the winding device 3 comprises a winding drive 6 for driving the coupling member 30 in rotation. Alternatively, the reel 4 may for example be driven in rotation by an external drive acting on an outer circumferential surface of the reel 4. For example, an external drive may be attached to an outer rim of one or both of the flanges 42.

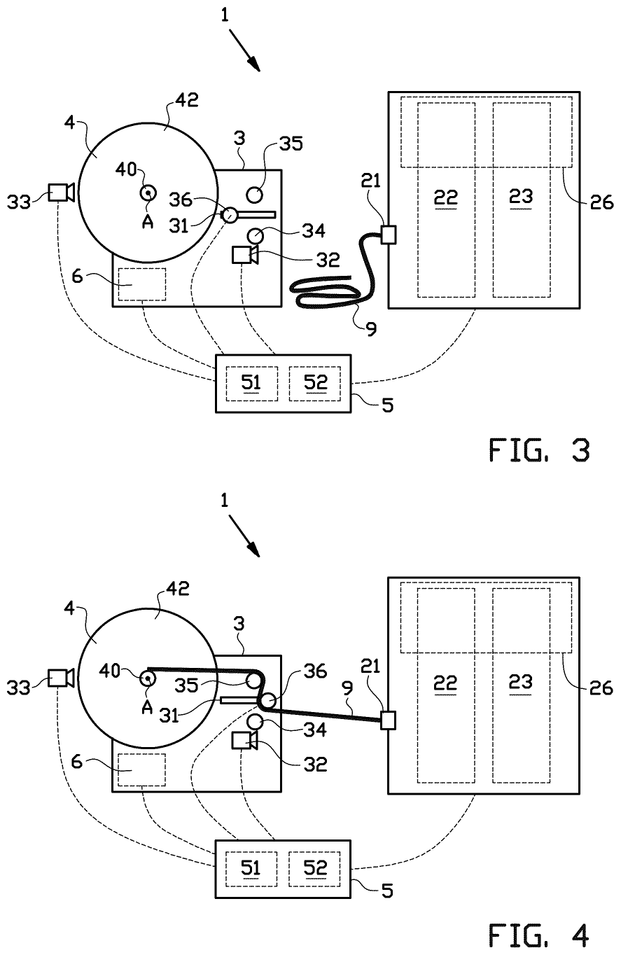

The winding device 3 further comprises a series of rollers 34, 35, 36 for guiding the string 9 of consecutive medicament pouches along a string trajectory S. Said string trajectory S extends between the packaging output 21 and the reel 4. The rollers 34, 35, 36 comprise a first guide roller 34, a second guide roller 35 and a dancer roller 36 between said first guide roller 34 and said second guide roller 35 along the string trajectory S. The dancer roller 36 is movable between a first position, as is shown in FIG. 3, and a second position at a distance spaced apart from said first position. Optionally, the dancer roller 36 is biased towards the first position. The dancer may for example be biased by a biasing element, such as a spring, or under the influence of gravity. In particular, the dancer roller 36 is arranged to be displaced towards the second position under the influence of the passing string 9.

The winding device comprises a first sensor 31 or dancer roller sensor for monitoring the position of said dancer roller 36. In particular, the first sensor 31 is arranged to detect the presence of the dancer roller 36 in the first position. The first sensor 31 may for example be a limit sensor.

Alternatively, the dancer roller 36 may be locked in the first position. Hence, in said first position, the dancer roller 36 may passively tension the string 9 e.g. by guiding said string 9 along an S-curve in cooperation with the first and second guide rollers 34, 35. The dancer roller 36 may further be unlocked and moved into or towards the second position to facilitate a mounting or unmounting of the string 9 on the reel 4.

As can best be seen in FIGS. 1 and 2, the winding device 3 comprises a second sensor 32 or path sensor arranged along the string trajectory S for detecting the presence or absence of the string 9. As is further shown in FIGS. 1 and 2, the string trajectory S is arranged to form a loop between the packaging output 21 and the first guide roller 34 of the of the winding device 3. Preferably, said loop is formed at or near the first guide roller 34. As is shown in FIGS. 1 and 2, the second sensor 32 is arranged along the string trajectory S, such that the second sensor 32 can detect the presence or absence of said loop or a surplus of the string 9. In particular, the second sensor 32 is arranged below the first guide roller 34.

In FIG. 1, a condition is shown in which a loop is formed in the string 9 which passes in front of the second sensor 32. Accordingly, the second sensor 32 can detect the presence of said string 9. FIG. 2 shows a condition in which the string 9 is tensioned and, as a consequence, does not pass in front of the second sensor. Accordingly, the second sensor can detect the absence of said spring 9. Preferably, the second sensor 32 comprises an optical sensor.

As is further shown in FIGS. 1-4, the winding device 3 comprises a third sensor 33 or reel sensor for detecting an amount of the string 9 wound around the reel 4. Said third sensor 33 may for example be a distance sensor. Alternatively, the third sensor 33 may for example be a load cell for measuring a mass of the reel 4.

The winding device 3 may comprise one or more additional sensors for detecting process parameters of winding device 3. For example, the winding device 3 may comprise a torque sensor (not shown) for measuring a torque of the winding drive 6.

The assembly 1 further comprises a control unit 5 which is operationally connected to the packaging device 2 and the winding device. In particular, the control unit 5 is operationally connected to the first sensor 31, the second sensor 32 and the third sensor 33 of the winding device 3. The control unit is further connected to the winding drive 6 of the winding device 3 and the packaging drive 26 of the packaging device 2. The control unit 5 may be connected to further sensors and/or drives (not shown).

The control unit 5 is arranged to communicate between the packaging device 2 and the winding device 3. Additionally, the control unit 5 may be arranged to provide feedback to either the packaging device 2, the winding device 3 or both. In particular, the control unit 5 is arranged to receive one or more packaging status signals from the packaging device 2 and to send one or more winding control signals to the winding device 3 in response to said one or more packaging status signals. Accordingly, the control unit 5 is arranged to receive one or more winding status signals from the winding device 3 and to send one or more packaging control signals to the packaging device 2 in response to said one or more winding status signals.

In particular, the control unit 5 is arranged to determine one or more winding statuses based on the received one or more winding status signals. The control unit 5 is further arranged to determine one or more packaging statuses based on the received one or more packaging status signals. The control unit 5 is programmed to generate a respective packaging control signal and/or a respective winding feedback signal in response to a respective winding status. Accordingly, the control unit 5 is programmed to generate a respective winding control signal and/or a respective packaging feedback signal in response to a respective packaging status.

A non-exhaustive number of examples of winding statuses and packaging statuses is described in more detail below:

The the control unit 5 may be arranged to determine a first winding status indicative of an error in transporting the string 9 between the packaging output and the reel 4, e.g. the string 9 may not be coupled to the reel. The first winding status may for example be determined when the presence of the dancer roller 36 in the first position is detected by the first sensor 31. Additionally or alternatively, when the desired string trajectory S comprises a loop at or near the second sensor 32, the first winding status may be determined when an absence of said loop of the string 9 is detected by the second sensor 32. Optionally, the control unit 5 may be programmed to only determine the first winding status when the first sensor 31 detects the dancer roller 36 in the first position while the second sensor 32 detects an absence of the string 9.

Additionally or alternatively, the control unit 5 may be arranged to measure a torque of the winding drive 6. The control unit 5 may be programmed to determine the first winding status when the torque of said winding drive 6 is below a predetermined threshold.

The control unit 5 is programmed to generate a first packaging control signal in response to detecting the first winding status. The control unit 5 is arranged to send said first packaging control signal to the packaging device 2. The first packaging control signal may for example comprise instructions to stop the transporting of the string 9 by the packaging drive 26. Additionally, the first packaging control signal may comprise instructions to stop the sealing and filling of the medicine pouches by the sealing station 22 and the filling station 23, respectively.

The control unit 5 may further be arranged to determine a second winding status indicative of a winding velocity at the reel 4 being higher than an output velocity of the string 9 at the packaging output 21. Said second winding status may for example be determined when the second sensor 32 detects the absence of the string 9 while the first sensor 31 detects the absence of the dancer roller 36 in the first position, i.e. when the dancer roller 36 is displaced towards the second position by the passing string 9.

The control unit 5 is programmed to generate a first winding feedback signal or further winding control signal in response to said second winding status. The control unit 5 is arranged to send said first winding feedback signal or further winding control signal to the winding device 3. The first winding feedback signal or further control signal may for example comprise instructions to the winding drive 6 to decrease the winding velocity at the reel 4.

Additionally or alternatively, the control unit 5 may be programmed to generate a packaging control signal in response to the second winding status. The packaging control signal may comprise instructions to the packaging device 2 to increase the output velocity of the string 9 at the packaging output 21.

The control unit 5 may further be arranged to determine a third winding status indicative of a winding velocity at the reel 4 being lower than an output velocity of the string 9 at the packaging output 21. When a desired string trajectory S does not comprise a loop at or near the location of the second sensor 32, the control unit 5 may be arranged to determine the third winding status when the second sensor 32 detects the presence of said loop of the string 9. Alternatively, when a desired string trajectory S does comprise a loop at or near the location of the second sensor 32, the control unit 5 may be arranged to determine the third winding status when the second sensor 32 detects the presence of the string 9 while the first sensor 31 detects the presence of the dancer roller 36 in the first position thereof. This may for example be the case when the string 9 is properly connected to the reel 4, but the tension in said string is insufficient to displace the dancer roller 36 away from the first position.

The control unit 5 is programmed to generate a second winding feedback signal or further winding control signal in response to said third winding status. The control unit 5 is arranged to send said second winding feedback signal or further winding control signal to the winding device 3. The second winding feedback signal or further winding control signal may for example comprise instructions to the winding drive 6 to increase the winding velocity at the reel 4.

Additionally or alternatively, the control unit 5 may be programmed to generate a packaging control signal in response to the third winding status. The packaging control signal may comprise instructions to the packaging device 2 to decrease the output velocity of the string 9 at the packaging output 21.

The control unit 5 may further be arranged to determine a fourth winding status indicative of the reel 4 being full. The control unit 5 may for example be arranged to determine the fourth winding status when an amount of the string 9 detected by the third sensor exceeds a predetermined threshold. For example, when the third sensor 33 is a load cell, said predetermined threshold may correspond to a maximum filling weight of the reel. Accordingly, the control unit may be arranged to determine a further winding status indicative of the reel 4 being absent when the third sensor 33 detects a weight below a predetermined threshold.

The control unit 5 is arranged to generate a second packaging control signal in response to said fourth winding status. The control unit 5 is arranged to send said second packaging control signal to the packaging device 2. The second packaging control signal may for example comprise instructions to stop the transporting of the string 9 by the packaging drive 26. Additionally, the first packaging control signal may comprise instructions to stop the sealing and filling of the medicine pouches by the sealing station 22 and the filling station 23, respectively.

The control unit 5 may further be arranged to determine a fifth winding status indicative of a malfunction of the winding device 3. The winding device 3 may for example be arranged to generate a winding status signal indicative of an error or malfunction of said winding device 3, such as a reel 4 not being present or a reel 4 not being coupled correctly to the coupling member.

The control unit 5 is programmed to generate a third winding feedback signal or further winding control signal in response to said fifth winding status. The control unit 5 is arranged to send said third winding feedback signal or further winding control signal to the winding device 3. Said third winding feedback signal or further winding control signal comprises instructions to drive the reel 4 in rotation in a direction opposite to the winding direction for a predetermined time interval. In other words, the feedback signal comprises instructions to unwind the reel 4. Unwinding the reel may allow an operator to check the winding device 3 for errors without being obstructed by the string 9.

The control unit 5 may further be arranged to determine a first packaging status indicative of a malfunction of the packaging device 2. Analogously to the winding device 3, the packaging device 2 may be arranged to generate a packaging status signal indicative of an error or malfunction of said packaging device 2. For example, the sealing station 22 may be jammed, or the discrete medicaments may block an aperture in the filling station 23.

The control unit 5 is programmed to generate a first winding control signal in response to said first packaging status. The control unit 5 is arranged to send said first winding control signal to the winding device 3. The first winding control signal may for example comprise instructions to stop the winding of the string 9 around the reel 4 by the winding device 3. Additionally, the control unit may be programmed to send a packaging feedback signal or further packaging control signal to said packaging device 2, comprising instructions to stop the transporting of the string 9 through said packaging device.

Exemplary method steps according to the method of the present invention will now be described using FIGS. 1-4.

FIG. 1 shows the assembly 1 in the situation that the amount of string 9 that is being output at the packaging output 21 is greater than the amount of string 9 that is being wound around the reel 4. As a consequence, the string 9 is sagging between the packaging output 21 and the second guide roller 35. In other words, a loop or surplus of the string 9 is formed along the string trajectory S. Said loop of the string 9 is detected by the second sensor 32, which sends a winding status signal to the control unit 5 indicative of the presence of the string 9 at said first sensor 32.

In the situation of FIG. 1, the string 9 has been coupled to the reel 4 correctly. Hence, the part of the string 9 passing the dancer roller 36 displaces said dancer roller 36 away from the first position thereof. Consequently the first sensor 31 does not detect the dancer roller 36 in the first position and sends a winding status signal to the control unit 5 indicative of the absence of the first dancer roller 36 in the first position.

The control unit 5 may now determine that the winding device 3 is in the third winding status, indicating that the winding velocity at the reel is lower than an output velocity at the packaging output 21. In response, the control unit 5 generates the second winding feedback signal. Accordingly, the control unit 5 sends instructions to the winding drive to 6 increase the winding velocity. Alternatively, the control unit 5 may send instructions to the packaging drive 26 to reduce a transport velocity of the string through the packaging device 2.

In an alternative configuration of the control unit 5, FIG. 1 may depict a normal operation condition of the assembly 1. In this case, the loop in the string trajectory S at the second sensor is intended. In this alternative configuration of the control unit 5, the control unit would detect the second winding status, indicative of a winding velocity at the reel 4 being higher than an output velocity of the string 9 at the packaging output 21, when the second sensor 32 detects the absence of the string 9 at said second sensor 32. Accordingly, the control unit could detect the third winding status, indicative of a winding velocity at the reel 4 being lower than an output velocity of the string 9 at the packaging output 21, when the first sensor 31 detects the presence of the dancer roller 36 in the first position.

FIG. 2 shows the assembly 1 in the situation that the reel 4 is full. The third sensor 33 sends a winding status signal to the control unit 5 indicative of the amount of string 9 on the reel 4 exceeding the predetermined threshold. Accordingly, the control unit 5 detects the fourth winding status. In response, the control unit 5 generates the second packaging control signal. Accordingly, the control unit 5 sends instructions to the packaging drive 26 of the packaging device 2 to cease the transport of the string 9 by said packaging device 2. Additionally, the control unit 5 may send a winding feedback signal or further winding control signal to the winding device 3 to cease the winding of the string 9 around the reel 4.

FIG. 3 shows the assembly 1 in the situation that the string 9 has not been connected to the reel 4. The dancer roller 36 has been urged into the first position by the bias thereof. Accordingly, the first sensor 31 detects the presence of the dancer roller 36 in said first position and sends a winding status signal to the control unit 5 indicating the same.

The second sensor 32 does not detect a loop of string 9 at the location of said second sensor 32. Consequently, the second sensor 32 sends a winding status signal to the control unit 5 indicative of the absence of the string 9 at said second sensor 32.

Accordingly, the control unit 5 detects the first winding status, indicative of an error in transporting the string between the packaging device 2 and the winding device 3. The control unit 5 subsequently generates the first packaging control signal. Accordingly, the control unit 5 sends instructions to the packaging device 2 to stop the transport of the string by the packaging drive 26. The control unit 5 may further be arranged to send instructions to the winding device 3 to stop the rotation of the winding drive 6.

FIG. 4 show the assembly 1 in the situation that the packaging process at the packaging device 2 is interrupted. In particular, the transport of the string 9 device has through the packaging 2 been stopped. Consequently, no length of the string 9 is being outputted at the packaging output 21.

The winding device 3 is still winding the string 9 around the reel 4. As a consequence, the string 9 is gradually tensioned between the packaging output 21 and the winding device 3. Said tension is partly compensated for by the dancer roller being displaced towards the second position thereof.

The packaging device 2 sends a first packaging status signal to the control unit 5 indicating an error or malfunction in said packaging device 2. Accordingly, the control unit 5 detects the first packaging status and generates instructions for the winding device 3 to cease the winding of the string 9 around the reel 4.

In an alternative configuration of the control unit 5, FIG. 4 may depict an operation condition of the assembly 1 in which the string 9 is wound around the reel 4 at a winding velocity that is greater than an output velocity of the string 9 at the packaging output 21. In this configuration of the control unit 5, the string trajectory S would in normal operation comprise a loop at the second sensor 32, as is depicted in FIG. 1.

In the alternative configuration of the control unit 5, the control unit 5 would receive a winding status signal from the second sensor 32 indicative of the string 9 being absent at the location of the loop in the string trajectory S. The control unit 5 would receive a winding status from the first sensor 31 indicative of the dancer roller 36 not being in the first position. Accordingly, the control unit 5 would detect the second winding status, indicative of a winding velocity at the reel 4 being higher than an output velocity of the string 9 at the packaging output 21. Hence, the control unit 5 would generate the first winding feedback signal or further winding control signal and would send instructions to the winding drive 6 to decrease the winding velocity.

As is shown in FIG. 1-4, the control unit 5 comprises a computer readable medium 52. The computer-readable medium 52 is non-transitory or tangible, e.g. a physical data carrier such as a hard-drive, a USB-drive, a RAM memory or the like. Said computer readable medium 52 comprises instructions for processing the one or more winding status signals and/or the one or more packaging status signals and, in response, generating the respective one or more winding control signals and/or one or more packaging control signals. The control unit further comprises a processing unit 51 for executing said instructions.

The present invention further relates to a computer-readable medium having computer-executable instructions adapted to cause the control unit 5 to execute the method steps as described above.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 assembly
2 packaging device
21 packaging output
22 sealing station
23 filling station
26 packaging drive
3 winding device
30 coupling member
300 drive shaft
301 cam
302 retaining member
31 first sensor or dancer roller sensor
32 second sensor or path sensor
33 third sensor or reel sensor
34 first guide roller
35 second guide roller
36 dancer roller
4 reel
40 reel hub
400 support surface
401 key lane
41 clamp
42 flange
5 control unit
51 processor
52 computer readable medium
6 winding drive
9 string
A central axis
B clamp axis
S string trajectory

1. Assembly for handling a string of consecutive medicament pouches, wherein the assembly (1) comprises a packaging device for packaging discrete medicaments in the respective medicament pouches of said string, a winding device for receiving the string from the packaging device and winding said string on a reel, and a control unit which is operationally connected to said packaging device and said winding device, wherein the control unit is arranged to:
receive one or more packaging status signals from the packaging device and to send one or more winding control signals to the winding device in response to said one or more packaging status signals; and/or
receive one or more winding status signals from the winding device and to send one or more packaging control signals to the packaging device in response to said one or more winding status signals; and the control unit is further arranged to:
determine a winding status based on the one or more winding status signals, that is indicative of one or more of:
an error in transporting the string between the packaging device and the winding device;
a difference between an output velocity of the string at a packaging output of the packaging device and a winding velocity of the string at the reel; and
a malfunction of the winding device.

2. Assembly according to claim 1, wherein the control unit is arranged to determine a winding status based on the one or more winding status signals, that is indicative of:
the reel being full.

3. Assembly according to claim 2, wherein the control unit is programmed to generate, in response to the detected winding status, a packaging control signal comprising one or more of the following instructions:
stopping the transport of the string by the packaging device;
increasing the output velocity of the string at the packaging output; and
decreasing the output velocity of the string at the packaging output.

4. Assembly according to claim 3, wherein the control unit is further programmed to generate in response to the detected winding status, a winding feedback signal to be sent back to the winding device,
wherein the winding feedback signal comprises one or more of the following instructions:
stopping the winding of the string by the winding device;
increasing the winding velocity of the string at the reel;
decreasing the winding velocity of the string at the reel; and
reversing a winding direction of the reel.

5. (canceled)

6. Assembly according to claim 2, wherein the winding device comprises one or more sensors which are operationally connected to the control unit for detecting the presence or absence of a string of consecutive medicament pouches.

7. Assembly according to claim 6, wherein the winding device comprises a dancer roller which defines at least a part of string trajectory (S) between the packaging output and the reel, wherein the dancer roller is movable between a first position and a second position, wherein the dancer roller is biased towards the first position, wherein the dancer roller is arranged to be displaced towards the second position under the influence of the passing string, and wherein the one or more sensors comprise a dancer roller sensor which is arranged to detect a presence of the dancer roller in at least one of the first position and the second position.

8. Assembly according to claim 6, wherein the one or more sensors comprise one or more of: a path sensor which is arranged to detect a presence or absence of the string along a desired string trajectory (S), a path sensor which is arranged to detect a presence or absence of a loop of the string outside a desired string trajectory, a reel sensor which is arranged to detect an amount of the string of consecutive medicament pouches wound around the reel, and a winding drive for driving the reel in rotation and a torque sensor for measuring a torque of said winding drive.

9. (canceled)

10. (canceled)

11. (canceled)

12. Assembly according to claim 1, wherein the control unit is arranged to determine a packaging status, based on the one or more packaging status signals, that is indicative of one or more of:
a sealing unit of the packaging device being opened;
an error in transporting the string between the packaging device and the winding device;
a difference between an output velocity of the string at a packaging output of the packaging device and a winding velocity of the string at the reel;
the reel being full; and
a malfunction of the packaging device.

13. Assembly according to claim 12, wherein the control unit is programmed to generate, in response to the detected packaging status, a winding control signal comprising one or more of the following instructions:
stopping the winding of the string by the winding device;
increasing the winding velocity of the string at the reel;
decreasing the winding velocity of the string at the reel; and
reversing a winding direction of the reel.

14. Assembly according to claim 13, wherein the control unit is further programmed to generate in response to the detected packaging status, a packaging feedback signal to be sent back to the packaging device,
wherein the packaging feedback signal comprises one or more of the following instructions:
stopping the transport of the string by the packaging device;
increasing the output velocity of the string at the packaging output; and
decreasing the output velocity of the string at the packaging output.

15. (canceled)

16. Assembly according to claim 1, wherein the winding device comprises a winding drive for driving the reel in rotation in a winding direction to wind the string around the reel, and/or wherein the packaging device comprises a packaging drive for transporting the string through the packaging device.

17. (canceled)

18. Assembly according to claim 1, wherein the control unit comprises a non-transitory computer readable medium comprising instructions for processing the one or more winding status signals and/or the one or more packaging status signals and, in response, generating the respective one or more winding control signals and/or one or more packaging control signals, and a processing unit for executing said instructions.

19. Method for handling a string of consecutive medicament pouches using the assembly according to claim 1, wherein the method comprises the steps of:
receiving one or more packaging status signals from the packaging device and sending one or more winding control signals to the winding device in response to said one or more packaging status signals; and/or
receiving one or more winding status signals from the winding device and sending one or more packaging control signals to the packaging device in response to said one or more winding status signals; and the method further comprises the step of:
determining a winding status, based on the one or more winding status signals, that is indicative of one or more of:
an error in transporting the string between the packaging device and the winding device;
a difference between an output velocity of the string at a packaging output of the packaging device and a winding velocity of the string at the reel; and
a malfunction of the winding device.

20. Method according to claim 19, wherein the method further comprises the step of determining a winding status, based on the one or more winding status signals, that is indicative of:
the reel being full.

21. Method according to claim 20, wherein the method further comprises the step of generating, in response to the detected winding status, a packaging control signal comprising one or more of the following instructions:
stopping the transport of the string by the packaging device;
increasing the output velocity of the string at the packaging output; and
decreasing the output velocity of the string at the packaging output.

22. Method according to claim 21, wherein the method comprises one or more of:
stopping the transport of the string by the packaging device in response to a winding status indicative of an in error in transporting the string between the packaging output and the reel;
increasing an output velocity of the string at a packaging output of the packaging device in response to a winding status indicative of a winding velocity at the reel being higher than the output velocity of the string;
decreasing an output velocity of the string at a packaging output of the packaging device in response to a winding status indicative of a winding velocity at the reel being lower than the output velocity of the string; and
stopping the transporting of the string by the packaging device in response to the reel being full.

23. (canceled)

24. (canceled)

25. (canceled)

26. Method according to claim 21, wherein the method further comprises the steps of generating in response to the detected winding status, a winding feedback signal and sending said winding feedback signal to the winding device,
wherein the winding feedback signal comprises one or more of the following instructions:
stopping the winding of the string by the winding device;
increasing the winding velocity of the string at the reel;
decreasing the winding velocity of the string at the reel; and
reversing a winding direction of the reel.

27. (canceled)

28. Method according to claim 26, wherein the method comprises one or more of:
decreasing a winding velocity at the reel in response to a winding status indicative of the winding velocity at the reel being higher than an output velocity of the string at a packaging output of the packaging device,
increasing a winding velocity at the reel in response to a winding status indicative of the winding velocity at the reel being lower than an output velocity of the string at a packaging output of the packaging device;
rotating the reel in a direction opposite to the winding direction for a predetermined time interval in response to a malfunction of the winding device.

29. (canceled)

30. (canceled)

31. Method according to claim 19, wherein the method comprises the step of determining a packaging status, based on the one or more packaging status signals, that is indicative of one or more of:
a sealing unit of the packaging device being opened;
an error in transporting the string between the packaging device and the winding device;
a difference between an output velocity of the string at a packaging output of the packaging device and a winding velocity of the string at the reel;
the reel being full; and
a malfunction of the packaging device.

32. Method according to claim 31, wherein the method further comprises generating, in response to the detected packaging status, a winding control signal comprising one or more of the following instructions:
stopping the winding of the string by the winding device;
increasing the winding velocity of the string at the reel;
decreasing the winding velocity of the string at the reel; and
reversing a winding direction of the reel.

33. (canceled)

34. (canceled)

35. (canceled)

36. A computer program product comprising a non-transitory computer-readable medium holding instructions that, when executed by a processor, causes an assembly to perform the steps of the method according to claim 19.
